(19) United States
(12) Patent Application Publication
(10) Pub. No.: US 2004/0252381 A1
(43) Pub. Date: Dec. 16, 2004

(54) Documentation camera and method of controlling operation thereof

(75) Inventor: Satoru Takagi, Tokyo (JP)

Correspondence Address: YOUNG & THOMPSON, 745 SOUTH 23RD STREET, 2ND FLOOR, ARLINGTON, VA, 22202, US

(73) Assignee: NEC VIEWTECHNOLOGY, LTD., TOKYO (JP)

(21) Appl. No.: 10/825,209

(22) Filed: Apr. 16, 2004

(30) Foreign Application Priority Data
Jun. 11, 2003 (JP) 2003-165842

(51) Int. Cl. G02B 27/14; G02B 15/14

(52) U.S. Cl. 359/676

(57) ABSTRACT

A documentation camera is capable of correcting a trapezoidal distortion and also adjusting the central position of a displayed image of a document when the image is zoomed in at the time the image is captured obliquely to the document. The zooming magnification of a zoom lens in a lens unit is detected by a zooming magnification detector, and a CPU searches a ROM based on the detected zooming magnification to read, from the ROM, parameters required in a trapezoidal distortion correcting process and also parameters required to adjust the central position of the displayed image. The CPU transmits the former parameters to a trapezoidal distortion correcting circuit to perform the trapezoidal distortion correcting process and also transmits the latter parameters to a shifting circuit to adjust the central position of the displayed image.

### BACKGROUND OF THE INVENTION

1. Field of the Invention

The present invention relates to a documentation camera (also known as a digital presenter, hereinafter referred to as “documentation camera”) and a method of controlling operation of such a documentation camera, and more particularly to a documentation camera for imaging materials including flat documents, three-dimensional objects, and slide films that serve as subjects, and outputting captured image signals to a display apparatus such as a projector, a television monitor, or the like, and a method of controlling operation of such a documentation camera.

2. Description of the Related Art

For presentations at meetings, academic society conferences, exhibitions, etc., there are widely used documentation cameras for imaging materials such as documents on plain paper, three-dimensional objects, slide films, etc, converting them into video signals, and displaying images of those materials based on the video signals on a display apparatus such as a projector, a television monitor, or the like.

A basic documentation camera has a lens unit that is positioned vertically above a material to be imaged, for capturing an image of the material. To allow the operator of the documentation camera to perform various operational actions such as the replacement of materials to be imaged and also to prevent the face of the presenter from being concealed from the audience by the lens unit, the lens unit can be displaced, i.e., offset, a certain distance from a position directly above the material to be imaged. Images that are captured by the lens unit that is offset from the position directly above the material to be imaged suffer trapezoidal distortion. Techniques for correcting such trapezoidal distortion are disclosed in Japanese laid-open patent publication No. 2002-325200 and Japanese laid-open patent publication No. 2003-18369.

According to the disclosure of Japanese laid-open patent publication No. 2002-325200, four light-emitting markers positioned on the respective vertexes of a square shape are placed on a presentation table for supporting a material to be imaged, and trapezoidal distortion of a captured image is corrected in order to align the four light-emitting markers respectively with the vertexes of a square shape in the image.

According to the arrangement disclosed in Japanese laid-open patent publication No. 2003-18369, an image of an object which is captured obliquely to the object is converted into an image as if it is captured forwardly of the object. The image conversion is performed in order to optically correct the positional relationship between the object and the image and also distortion of the image.

When the above documentation camera is used to image a material and give a presentation about the material, the user may either display the material in its entirety and explain the material, or display a portion of the material and explain the displayed portion of the material. The conventional systems disclosed in the above publications can correct trapezoidal distortion produced when the material is displayed in its entirety, but do not take into account and are not applicable to the correction of trapezoidal distortion produced when a portion of the material is displayed at an enlarged scale, i.e., when it is zoomed in.

The reason for the failure is that when a portion of the material is displayed at an enlarged scale or zoomed in, the image suffers different levels of trapezoidal distortion depending on the zooming position, i.e., the magnification of the zoom-in process.

Another problem of the conventional systems is as follows: When the material to be imaged is read directly from above, the lens unit has its optical axis aligned with the center of the displayed position of the captured image. However, when the material to be imaged is read from a position not directly from above, i.e., from an offset position, the material is read obliquely to the material. In this case, even if the lens unit has its optical axis aligned with the center of the displayed position of the captured image, the magnification of the zoom-in process at a position displaced from the center of the image differs depending on the distance that the position is displaced from the center of the image. Therefore, when a portion of the material is zoomed in, an image different from the portion of the material to be zoomed in is displayed. Each time the material is to be zoomed in, the operator needs to adjust the position of the material depending on the zoom-in process, and hence finds the conventional systems clumsy to operate.

### SUMMARY OF THE INVENTION

It is an object of the present invention to provide a documentation camera which is capable of correcting trapezoidal distortion at any zooming position (zooming magnifications) when a material is zoomed in to display a portion of the material at an enlarged scale.

Another object of the present invention is to provide a documentation camera which is capable of keeping the same central image as prior to a zooming process at any zoom position of the zooming process, allowing enlarged images to be displayed as desired by the operator.

According to the present invention, a documentation camera having a lens unit for imaging a subject, the lens unit having a zooming function, comprises zooming magnification detecting means for detecting a magnification based on the zooming function.

The documentation camera also has means for positioning the lens unit so as to be displaced offset from a position directly above the subject, and trapezoidal distortion correcting means for correcting a trapezoidal distortion of an image captured by the lens unit depending on the magnification detected by the zooming magnification detecting means.

The trapezoidal distortion correcting means has memory means for storing parameters required to correct a trapezoidal distortion of an image, in association with each of magnifications detected by the zooming magnification detecting means, and means for reading parameters corresponding to the magnification detected by the zooming magnification detecting means from the memory means, and correcting the trapezoidal distortion according to the read parameters. The documentation camera further comprises shifting means for shifting a displayed position of the image depending on the offset.

The memory means stores parameters required to shift a displayed position of the image depending on the offset, and the shifting means reads parameters required to shift a displayed position of the image depending on the offset, from the memory means, and shifts the displayed position of the image according to the read parameters.

According to the present invention, there is also provided a method of controlling operation of a documentation camera having a lens unit for imaging a subject, the lens unit having a zooming function, comprising the step of detecting a magnification based on the zooming function.

The lens unit is positionable so as to be displaced offset from a position directly above the subject, and the method further comprises the step of correcting a trapezoidal distortion of an image captured by the lens unit depending on the magnification which is detected. The method further comprises the step of providing memory means for storing parameters required to correct a trapezoidal distortion of an image, in association with each magnification which is detected, and the step of correcting a trapezoidal distortion comprises the steps of reading parameters corresponding to the magnification which is detected from the memory means, and correcting the trapezoidal distortion according to the read parameters.

The method further comprises the step of shifting a displayed position of the image depending on the offset, with respect to an output produced after the trapezoidal distortion has been corrected. The memory means stores parameters required to shift a displayed position of the image depending on the offset and the magnification, and the step of shifting a displayed position includes the steps of reading parameters required to shift a displayed position of the image depending on the offset and the magnification, from the memory means, and shifting the displayed position of the image according to the read parameters.

Operation of the documentation camera according to the present invention will briefly be described below. The documentation camera with the zooming function has a function to detect a zooming magnification. When the zooming function is performed at the time the subject is imaged obliquely thereto, the magnification detecting function detects the zooming magnification, and the trapezoidal distortion correcting process is performed depending on the detected magnification. Since the trapezoidal distortion varies depending on the zooming magnification, parameters required in the trapezoidal distortion correcting process are stored in ROM tables in association with various magnifications, and parameters corresponding to an actual magnification are read from the corresponding ROM table and the trapezoidal distortion is corrected according to the read parameters.

Because the central position of a displayed image is displaced, an image shifting process is carried out to correct the central position of the displayed image. At this time, the distance that the central position of the displayed image is displaced also varies depending on the zooming magnification. Therefore, parameters for shifting the central position of the displayed image are also stored in ROM tables in association with zooming magnifications.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a documentation camera according to an embodiment of the present invention;

FIG. 2(A) is a side elevational view of the documentation camera with a lens unit disposed in a position directly above a material (subject) to be imaged;

FIG. 2(B) is a side elevational view of the documentation camera with the lens unit displaced offset from the position directly above the material to be imaged, for imaging the material in an oblique direction;

FIG. 3 is a view showing an image captured by the lens unit positioned as shown in FIG. 2(A);

FIG. 4 is a view showing an image captured by the lens unit positioned as shown in FIG. 2(B);

FIG. 5 is a flowchart of an operation sequence of a trapezoidal distortion correcting process;

FIG. 6 is a view showing an image in a step of the trapezoidal distortion correcting process;

FIG. 7 is a view showing an image in another step of the trapezoidal distortion correcting process;

FIGS. 8(A) through 8(D) are views showing images in other steps of the trapezoidal distortion correcting process;

FIG. 9 is a view showing a zooming magnification detector;

FIG. 10 is a flowchart of an operation sequence of a trapezoidal distortion correcting process performed when a material to be imaged is zoomed in;

FIGS. 11(A) through 11(C) are views illustrative of positional adjustments made after the trapezoidal distortion correcting process when the material to be imaged is zoomed in;

FIG. 12 is a flowchart of an operation sequence of an image shifting process; and

FIG. 13 is a view illustrative of an example of the image shifting process.

### DETAILED DESCRIPTION OF THE PREFERRED EMBODIMENTS

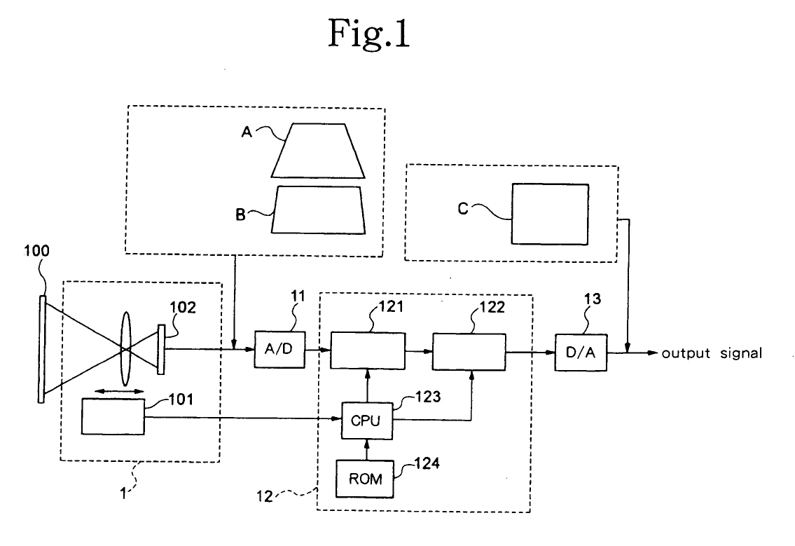

FIG. 1 shows in block form a documentation camera according to an embodiment of the present invention. As shown in FIG. 1, subject 100 which is a material such as a document or the like to be imaged is imaged and converted into an electric signal by lens unit 1 having a zooming function. The electric signal is then converted into a digital signal by A/D (analog-to-digital) converter 11. The digital signal is supplied to signal processor 12 in which it is subjected to a trapezoidal distortion correcting process and an image shifting process respectively by trapezoidal distortion correcting circuit 121 and shifting circuit 122. The digital signal processed by signal processor 12 is supplied to D/A (digital-to-analog) converter 13, which converts the digital signal into an analog signal and outputs the analog signal.

Lens unit 1 has zooming magnification detector 101 and CCD sensor 102. Signal processor 12 has CPU 123 and ROM 124. CPU 123 reads signal processing parameters stored in ROM 124 depending on a zooming magnification detected by zooming magnification detector 101, and controls operation of trapezoidal distortion correcting circuit 121 and shifting circuit 122 based on the read signal processing parameters.

In FIG. 1, images captured by CCD sensor 102, which serves as an imaging camera, include image A having a trapezoidal distortion produced before image A is zoomed in, and image B having a trapezoidal distortion produced after image B is zoomed in. An image whose trapezoidal distortion has been corrected is represented by C.

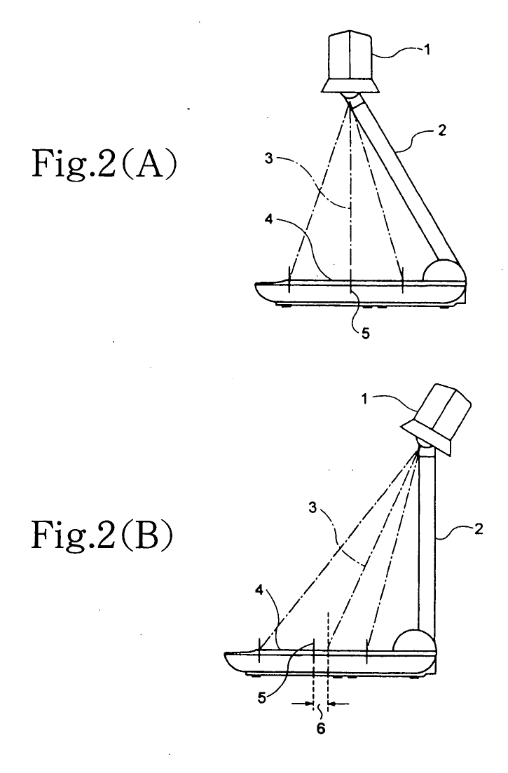

FIGS. 2(A) and 2(B) show in side elevation the documentation camera according to the embodiment of the present invention. FIG. 2(A) shows the documentation camera with lens unit 1 disposed in a position directly above a material (not shown) to be imaged on subject holder 4. FIG. 2(B) shows the documentation camera with lens unit 1 displaced offset from the position directly above the material to be imaged, for imaging the material in an oblique direction.

In FIGS. 2(A) and 2(B), lens unit 1 is mounted on arm 2 and has optical axis 3. A display screen has central position 5, which also represents the central position of the material (not shown) to be imaged. As shown in FIG. 2(A), when lens unit 1 is disposed in the position directly above the material, i.e., when lens unit 1 is not offset, optical axis 3 of lens unit 1 is aligned with central position 5 of the captured image. However, as shown in FIG. 2(B), when lens unit 1 is offset, optical axis 3 of lens unit 1 passes through a position displaced from central position 5 of the captured image. The distance that the position is displaced from central position 5 is indicated by 6 in FIG. 2(B).

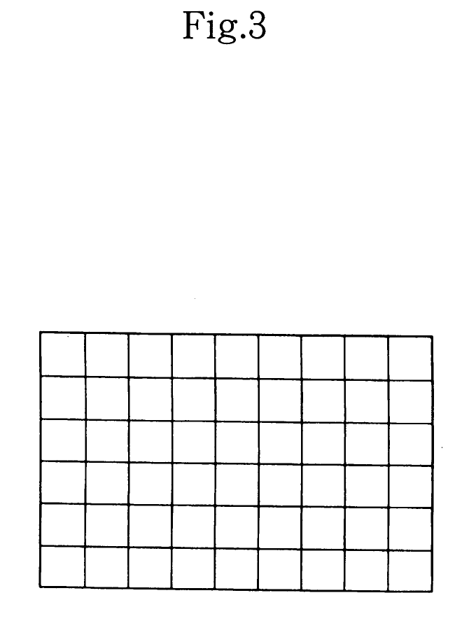

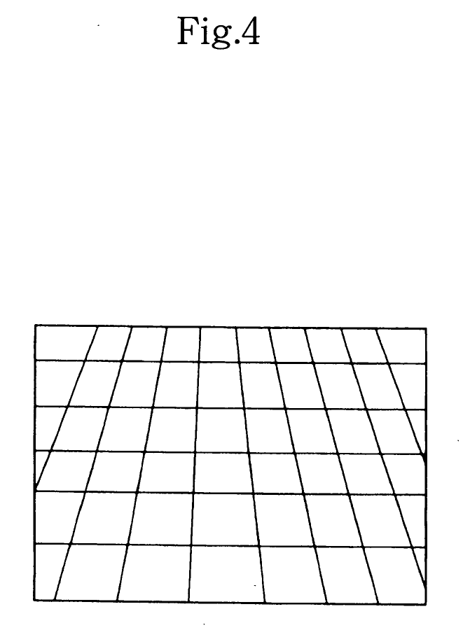

FIG. 3 shows an image captured by lens unit 1 which is not offset as shown in FIG. 2(A), and FIG. 4 shows an image captured by lens unit 1 which is offset as shown in FIG. 2(B).

As shown in FIG. 4, the image captured by lens unit 1 suffers a trapezoidal distortion when lens unit 1 is offset. In each of FIGS. 3 and 4, for the purpose of judging a distortion with ease, the captured image is divided by a plurality of horizontal and vertical straight lines, i.e., a grid pattern, and represented as a collection of square unit figures.

The captured image with a trapezoidal distortion, which is shown in FIG. 4, needs to be corrected for the trapezoidal distortion. A process of correcting such a trapezoidal distortion is known in the art as disclosed in the above patent documents, and also known as a “deformation command” such as “perspective” in commercially available image processing applications. The process of correcting a trapezoidal distortion will briefly be described below.

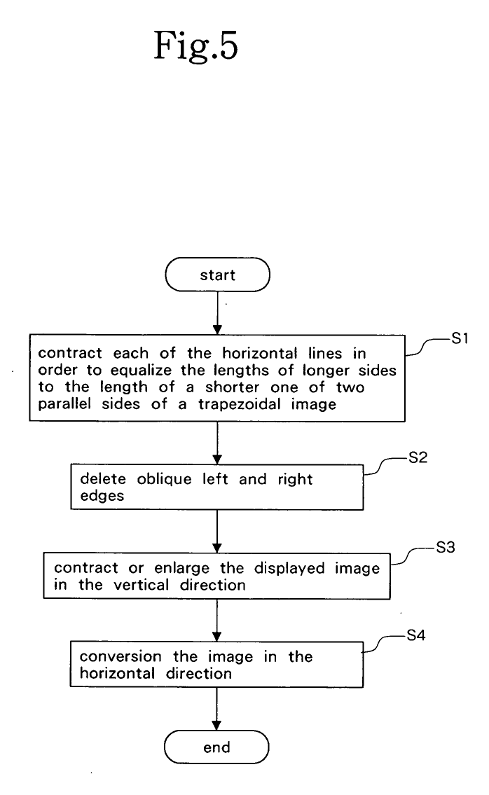

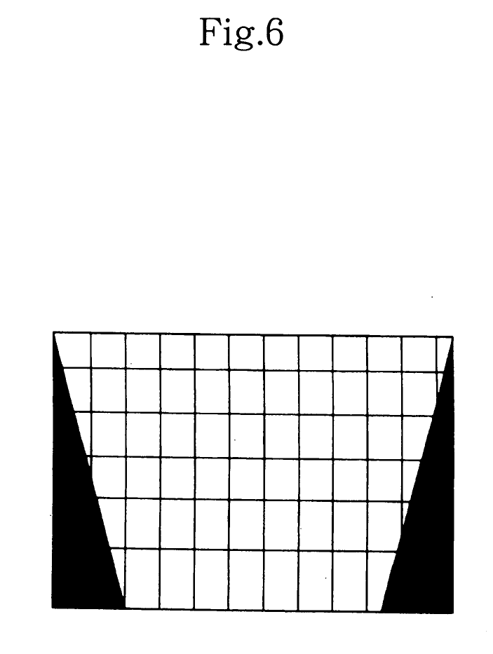

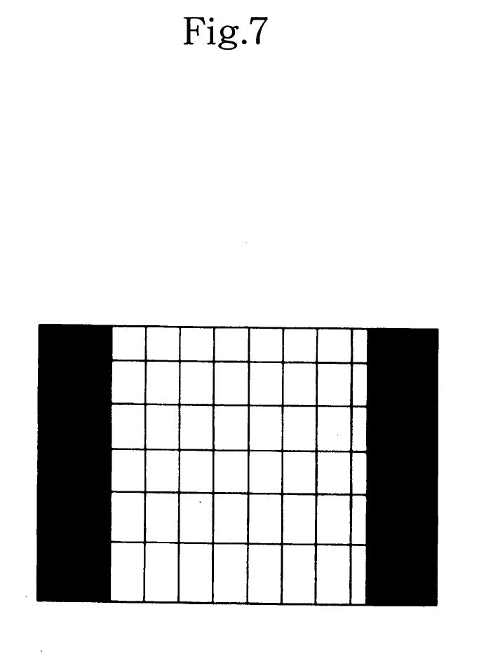

FIG. 5 is a flowchart of an operation sequence of a trapezoidal distortion correcting process. Each of the horizontal lines is contracted in order to equalize the lengths of longer sides to the length of a shorter one of two parallel sides of a trapezoidal image shown in FIG. 4 (STEP S1). At this time, as shown in FIG. 6, since the distance from the lens to the upper side of the image and the distance from the lens to the lower side of the image are different from each other, the vertical sizes of the unit figures are displayed so as to be more contracted on the shorter side (the upper side of the image) than on the longer side (the lower side of the image). At this time, the displayed image has left and right edges extending obliquely. As shown in FIG. 7, the oblique left and right edges are deleted, producing a rectangular displayed image (STEP S2).

Then, the displayed image is contracted or enlarged in the vertical direction (STEP S3). Specifically, each line is vertically contracted to equalize the vertical sizes of all the unit figures to the vertical sizes of unit figures on the upper side of the image.

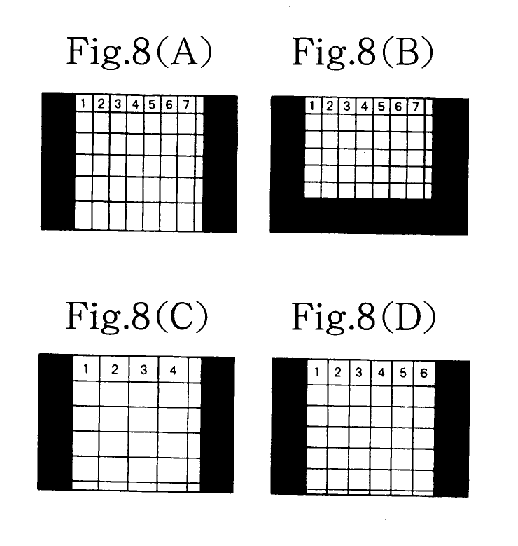

FIG. 8(A) shows an image displayed before it is processed in the vertical direction, the image being the same as the image shown in FIG. 7. FIG. 8(B) shows an image displayed after it is processed in the vertical direction. Numerals in FIGS. 8(A) and 8(B) represent serial numbers assigned to successive unit figures. When the image is contracted in the vertical direction, it is shifted upwardly as shown in FIG. 8(B). Conversely, when the image is enlarged to equalize the vertical sizes of all the unit figures to the vertical sizes of unit figures on the lower side of the image, then an enlarged image is displayed as shown in FIG. 8(C). Such a process of vertically contracting or enlarging an image is carried out in STEP S3.

If the documentation camera supports both functions of enlarging and contracting images, then it can enlarge unit squares on the upper side of the image and contact unit squares on the lower side of the image to equalize the vertical sizes of all the unit figures to the vertical sizes of unit figures on the central area of the image. In this case, an image shown in FIG. 8(D) is displayed.

When the vertical image size conversion is performed in STEP S3, the image is vertically expanded or shrunk. Therefore, the image needs to be processed for horizontal image size conversion to match the vertical dimensions. According to the horizontal image size conversion, a vertically elongate image is horizontally enlarged and a vertically short image is horizontally contracted so that the vertical sizes of the unit figures and the horizontal sizes of the unit figures have a ratio of 1:1 (STEP S4). The trapezoidal distortion correcting process is now completed.

The trapezoidal distortion correcting process shown in FIG. 5 is executed by trapezoidal distortion correcting circuit 121 shown in FIG. 1. The trapezoidal distortion correcting process described above is a process that is performed when the zooming function of lens unit 1 is not employed, and is of known nature as described above.

An image processing sequence at the time the zooming function of lens unit 1 is employed will be described below. When lens unit 1 is offset as shown in FIG. 2(B), the angle of the trapezoidal distortion of the image obliquely captured by lens unit 1 before the image is zoomed in changes after the image is zoomed in. As indicated by images A, B captured by CCD sensor 102, the angle of the trapezoidal distortion is sharper before the image is zoomed in than it is after the image is zoomed in. In order to correct the trapezoidal distortion regardless of the zooming position (corresponding to the magnification of the zooming process), it is necessary to acquire the zooming position, i.e., the magnification.

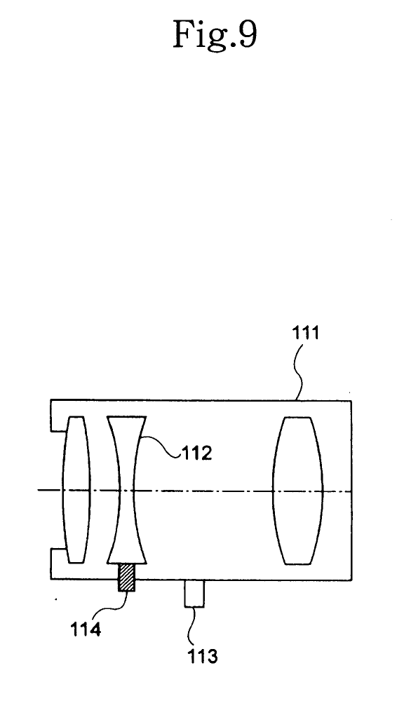

For acquiring how much the image is zoomed in, lens unit 1 has zooming magnification detector 101. As shown in FIG. 9, zooming magnification detector 101 has detector (sensor) 113 for detecting the position of movable lens 1 12 in zoom lens 111. Sensor 113 is mounted in a reference zoom position for detecting the zooming magnification (the zooming position) based on the distance that movable lens 112 is moved. Specifically, the position where tooth 114 of movable lens 112 moves across sensor 113 is used as a reference position, and the magnification is detected as the number of steps that a step motor (not shown) for actuating movable lens 112 has turned from the reference position. Preferably, sensor 113 should comprise a photointerruptor. If the magnification can be grasped directly from a drive signal supplied to a DC motor or a step motor for actuating movable lens 112, then such a drive signal may be employed to detect the magnification.

The magnification thus detected is supplied to CPU 123 for use as a readout address for ROM 124. ROM 124 stores a ROM table of parameters required in a trapezoidal distortion correcting process that is performed by trapezoidal distortion correcting circuit 121 and parameters required in an image shifting process that is performed by shifting circuit 122 depending on a shift of the central position of displayed images, the parameters being associated with magnifications.

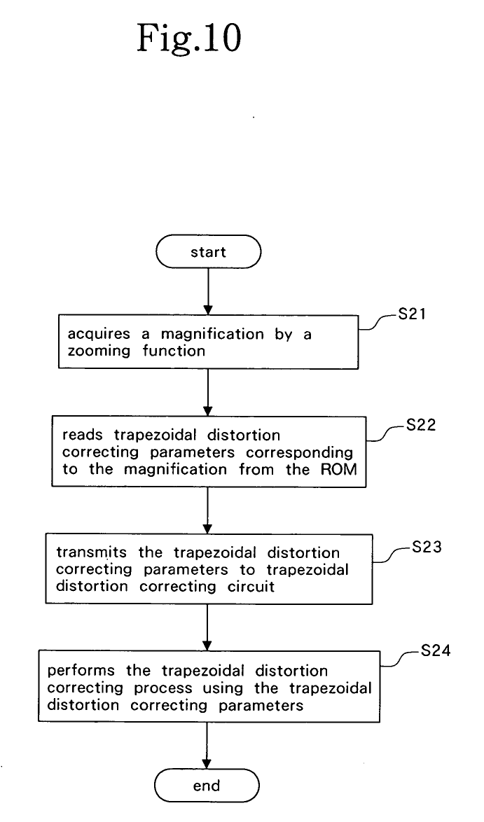

FIG. 10 is a flowchart of an operation sequence of a trapezoidal distortion correcting process performed when a material to be imaged is zoomed in. The trapezoidal distortion correcting process will be described below with reference to FIG. 10. A magnification achieved by a zooming action is acquired (STEP S21). The acquired magnification is detected by zooming magnification detector 101 and input to CPU 123. CPU 123 reads trapezoidal distortion correcting parameters corresponding to the magnification from the ROM table stored in ROM 124 (STEP S22). The parameters represent the data of lengths of two parallel sides of a trapezoidal shape, the data of angles at which the other two sides cross the two parallel sides, the data of enlarging and contracting ratios of each vertical line of the trapezoidal shape, and the data of enlarging and contracting ratios of each horizontal line of the trapezoidal shape.

A trapezoidal shape is uniquely determined if the lengths of two parallel sides, the angles at which the other two sides cross the two parallel sides, and a height are known. Since the height of a trapezoidal shape is constant with respect to the documentation camera, the above length data and the angle data are used as parameters which define the trapezoidal shape.

Once a trapezoidal shape is uniquely defined, the trapezoidal distortion correcting process shown in FIG. 5 can be performed. According to the present embodiment, for making the trapezoidal distortion correcting process faster, the vertical and horizontal enlarging and contracting ratios required in STEP S1, STEP S3, STEP S4 shown in FIG. 5 are also read as parameters from the ROM table.

Trapezoidal distortions also change depending on the offset of lens unit 1 shown in FIG. 2(B). In many documentation camera applications, the offset of lens unit 1 is variable stepwise in several stages. According to the present embodiment, the documentation camera is also arranged such that the offset of lens unit 1 is variable stepwise in several stages. ROM 124 stores as many ROM tables as the number of stages or steps in which the offset of lens unit 1 is variable. Zooming magnification detector 101 of lens unit 1 outputs a signal indicative of the present offset of lens unit 1 to CPU 123, which reads various parameters from the ROM table in ROM 124 which corresponds to the present offset of lens unit 1.

CPU 124 transmits the parameters read from the ROM table to trapezoidal distortion correcting circuit 121 (STEP S23). Trapezoidal distortion correcting circuit 121 performs the trapezoidal distortion correcting process according to the flowchart shown in FIG. 5 (STEP S24).

As shown in FIG. 2(B), when lens unit 1 is offset and images the material in an oblique direction, optical axis 3 of lens unit 1 is not aligned with the central position of the captured image.

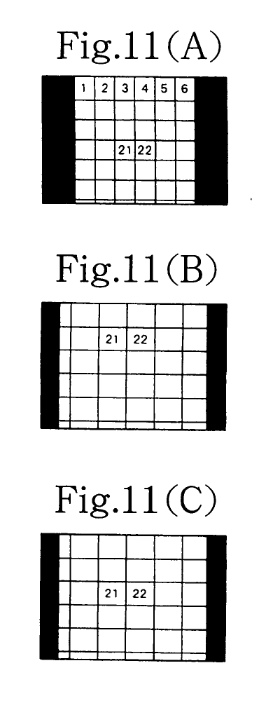

FIG. 11(A) shows the captured image before it is zoomed in, and FIG. 11(B) shows the captured image after a zooming process (the trapezoidal distortion correcting process) is performed. As shown in FIG. 11(B), the image which has been subjected to the zooming process has its central position shifted out of alignment with the central position of the image shown in FIG. 11(A). Therefore, it is necessary for shifting circuit 122 to shift the displayed position of the image to bring the central position of the image into alignment with the central position of the image shown in FIG. 11(A). FIG. 11(C) shows the captured image that has been processed by the image shifting process performed by shifting circuit 122.

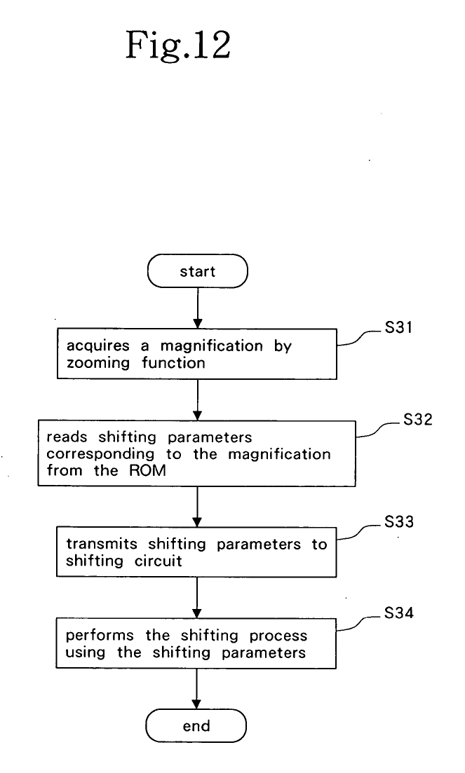

FIG. 12 is a flowchart of an operation sequence of the image shifting process. As shown in FIG. 12, zooming magnification detector 101 detects a magnification and inputs the detected magnification to CPU 123, which acquires a magnification based on the zooming function (STEP S31). The acquired magnification is used as a readout address for ROM 124. CPU 123 reads parameters required in the image shifting process based on the acquired magnification from the ROM table stored in ROM 124 (STEP S32), and transmits the parameters to shifting circuit 122 (STEP S33). Shifting circuit 122 now performs the image shifting process using the parameters (STEP S34).

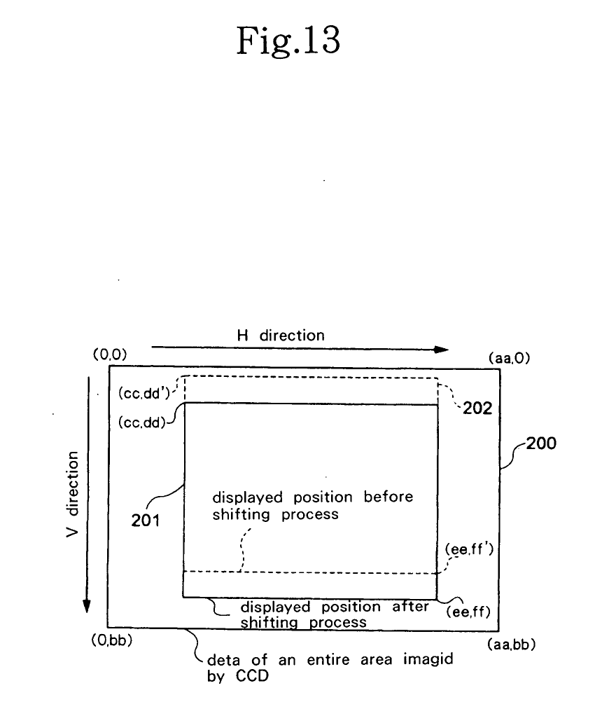

The image shifting process performed by shifting circuit 122 is a process of extracting a signal of the displayed position from the signal that has been processed by trapezoidal distortion correcting circuit 121. FIG. 13 shows details of such an extracting process.

In FIG. 13, the signal that has been processed by trapezoidal distortion correcting circuit 121 represents data 200 of an entire area imaged by CCD sensor 102. Data 200 are in synchronism with a signal in the horizontal (H) direction and a signal in the vertical (V) direction. An area to be extracted from data 200 can be indicated by specifying a leading position in the H direction and a leading position in the V direction and also specifying a data length in the H direction and a data length in the V direction. Therefore, parameters representing an area to be extracted comprise the leading positions in the H and V directions and the data lengths in the H and V directions.

FIG. 13 illustrates area 201 to be extracted when the image shifting process is not performed. Area 201 starts being extracted from the position “cc” in the H direction and the position “dd” in the V direction, and the data from those positions up to the position “ee” in the H direction and the position “ff” in the V direction are transmitted to D/A converter 13. When the image shifting process is performed, those extracting positions are changed. Specifically, an area starts being extracted from the position “cc” in the H direction and the position “dd′” in the V direction, and the data from those positions up to the position “ee” in the H direction and the position “ff′” in the V direction are transmitted to D/A converter 13. Thus, an image represented by 201 is shifted to an image represented by 202.

The shifted distance achieved by the image shifting process changes depending on the offset of lens unit 1. If the offset of lens unit 1 is variable stepwise, then shifted distances may be stored in as many tables as the number of stages or steps in which the offset of lens unit 1 is variable.

In the embodiment shown in FIG. 1, trapezoidal distortion correcting circuit 121 and shifting circuit 122 are shown as being separate from CPU 123. However, the trapezoidal distortion correcting process performed by trapezoidal distortion correcting circuit 121 and the image shifting process performed by shifting circuit 122 may be stored as respective programs in ROM 124, and those programs may be read and executed by CPU (computer) 123.

The present invention is advantageous in that an image of a subject such as a document or the like which is captured by the lens unit obliquely to the subject can be displayed as if it is captured directly from above the subject even when the image is zoomed in. The reason for the advantage is that the magnification of the zoomed-in image is detected, and the trapezoidal distortion correcting process and the image shifting process can be performed using the detected magnification.

While preferred embodiments of the present invention have been described using specific terms, such description is for illustrative purposes only, and it is to be understood that changes and variations may be made without departing from the spirit or scope of the following claims.

What is claimed is:

1. A documentation camera having a lens unit for imaging a subject, the lens unit having a zooming function, comprising:
zooming magnification detecting means for detecting a magnification based on the zooming function; and
trapezoidal distortion correcting means for correcting a trapezoidal distortion of an image captured by the lens unit depending on the magnification detected by said zooming magnification detecting means.

2. A documentation camera according to claim 1, wherein said trapezoidal distortion correcting means has memory means for storing parameters required to correct a trapezoidal distortion of an image, in association with each of magnifications detected by said zooming magnification detecting means, and said trapezoidal distortion correcting means reads parameters corresponding to the magnification detected by said zooming magnification detecting means from said memory means, and corrects the trapezoidal distortion according to the read parameters.

3. A documentation camera according to claim 1, wherein said lens unit is positionable so as to be displaced offset from a position directly above said subject, further comprising:
shifting means for shifting a displayed position of the image depending on said offset.

4. A documentation camera according to claim 2, wherein said lens unit is positionable so as to be displaced offset from a position directly above said subject, and said memory means stores parameters required to shift a displayed position of the image depending on said offset, further comprising:
shifting means for reading parameters required to shift a displayed position of the image depending on said offset, from said memory means, and shifting the displayed position of the image according to the read parameters.

5. A documentation camera according to claim 3, wherein said shifting means shifts the displayed position of the image whose trapezoidal distortion has been corrected by said trapezoidal distortion correcting means.

6. A documentation camera according to claim 4, wherein said 15 shifting means shifts the displayed position of the image whose trapezoidal distortion has been corrected by said trapezoidal distortion correcting means.

7. A method of controlling operation of a documentation camera having a lens unit for imaging a subject, the lens unit having a zooming function, comprising the steps of:
detecting a magnification based on the zooming function; and
correcting a trapezoidal distortion of an image captured by the lens unit depending on the magnification which is detected.

8. A method according to claim 7, further comprising the step of:
providing memory means for storing parameters required to correct a trapezoidal distortion of an image, in association with each of magnifications which are detected;
wherein said step of correcting a trapezoidal distortion comprises the steps of reading parameters corresponding to the magnification which is detected from said memory means, and correcting the trapezoidal distortion according to the read parameters.

9. A method according to claim 7, further comprising the steps of:
positioning said lens unit so as to be displaced offset from a position directly above said subject; and
shifting a displayed position of the image depending on said offset.

10. A method according to claim 8, further comprising the steps of:
positioning said lens unit so as to be displaced offset from a position directly above said subject;
storing in said memory means parameters required to shift a displayed position of the image depending on said offset; and
reading parameters required to shift a displayed position of the image depending on said offset, from said memory means, and shifting the displayed position of the image according to the read parameters.

11. A method according to claim 9, wherein said step of shifting the displayed position of the image is carried out after said step of correcting the trapezoidal distortion.

12. A method according to claim 10, wherein said step of shifting the displayed position of the image is carried out after said step of correcting the trapezoidal distortion.
